(19) United States
(12) Patent Application Publication
(10) Pub. No.: US 2007/0194015 A1
(43) Pub. Date: Aug. 23, 2007

(54) Microwave oven

(76) Inventor: Kyu Young Kim, Gyeongsangnam-do (KR)

Correspondence Address: KED & ASSOCIATES, LLP, P.O. Box 221200, Chantilly, VA, 20153-1200, US

(21) Appl. No.: 10/575,860

(22) PCT Filed: Oct. 12, 2004
(86) PCT No.: PCT/KR04/02597

§ 371 Date: Jan. 25, 2007

(30) Foreign Application Priority Data
Oct. 16, 2003 (KR) 10-2003-0072318
Feb. 23, 2004 (KR) 10-2004-0011913

(51) Int. Cl. H05B 6/64

(52) U.S. Cl. 219/757

(57) ABSTRACT

Microwave oven including a body (100) forming an outer appearance, an inner case (110) in the body (100) having a cooking chamber (110a) formed therein, an outfit room (150) at one side of the inner case (110), having various electric parts, such as a magnetron (170), a high voltage transformer (180), mounted therein, and a convection assembly (200) mounted at a side of the inner case (110), for transmitting heat to the cooking chamber (110a), thereby providing an excellent performance even with a small size.

### TECHNICAL FIELD

The present invention relates to microwave ovens, and more particularly, to a microwave oven of which performance is excellent even if a size thereof is small.

### BACKGROUND ART

In general, the microwave oven cooks food, not by burning gas like a gas oven range, but by raising an inside temperature with electricity, or directing a microwave to the food.

Since the microwave oven generates no flame, and has no gas leakage hazard, which provides the advantage of low risk of accidents caused by negligence of safety, the microwave oven obtains good response from consumers.

FIG. 1 illustrates a section of a related art microwave oven.

Referring to FIG. 1, the related art microwave oven is provided with a body 1 forming an outer appearance, and an inner case 2 inside of the body 1 having a cooking chamber 2a formed therein.

In a front of the body 1, there are a door 4 for opening/closing the cooking chamber 2a, and a control panel 3 for manipulation by a user, and the like.

In an upper surface of the inner case 2, there are a heater 5 and a reflective plate 6 surrounding the heater 5, and, in a rear surface of the inner case 2, there is a convection assembly 7 for transmission of heat to the cooking chamber 2a.

In the cooking chamber 2a, there is a turntable 10 for placing food thereon, with a driving motor 8 and a roller 9 under the turntable 10 for rotating the turntable 10.

Of course, though not shown, inside of the body 1 is an outfit room having various electric parts and fittings, such as a magnetron for generating the microwave, and a high voltage transformer.

The operation of the related art microwave oven will be described briefly.

Upon placing food on the turntable 10, the turntable 10 rotates by the driving motor 8 and the roller 9. At the same time with the rotation of the turntable 10, the heater 5 emits heat to cook the food.

In this instance, the convection assembly 7 transmits heat to the food in the cooking chamber 2a, too. In more detail, the convection assembly 7 elevates an inside temperature of the cooking chamber up to 200˜300° to heat the food, adequately.

In the meantime, recently, there are many microwave ovens each installed on a cooking appliance, such as a gas range, or gas oven range, for discharging heat, smoke, or smell from the cooking appliance to an outside of a room. In general, such a microwave oven is called as an OTR (Over The Range) type microwave oven.

FIG. 2 illustrates a section a related art OTR type microwave oven.

Referring to FIG. 2, the related art OTR type microwave oven has a structure the same with a general microwave oven, and is installed over a cooking appliance 12 like the gas range.

However, the related art OTR type microwave oven is provided with a ventilating device (not shown) for making quick discharge of moisture or smoke produced in a course of cooking from the cooking appliance 12 to an outside of the room.

Accordingly, the related art OTR type microwave oven has a function of making a room environment comfortable by discharging smoke or smell from the cooking appliance 12 to the outside of the room, together with a function of cooking food.

However, the provision of the convection assembly 7 to the rear of the inner case 2 of the related art OTR type microwave oven increases a front-rear distance, unnecessarily.

That is, referring to FIGS. 1 and 2, the related art microwave oven has a front-rear distance increased by L1 for mounting the convection assembly 7. Therefore, since it is also required to reduce a size of the cooking chamber 2a for reducing the front-rear distance of the related art microwave oven, there has been a limitation in making the microwave oven smaller.

### DISCLOSURE OF INVENTION

An object of the present invention is to provide a microwave oven which has a good performance even if a size thereof is small.

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these objects and other advantages and in accordance with the purpose of the present invention, as embodied and broadly described herein, a microwave oven includes a body forming an outer appearance, an inner case in the body having a cooking chamber formed therein, an outfit room at one side of the inner case, having various electric parts, such as a magnetron, a high voltage transformer, mounted therein, and a convection assembly mounted at a side of the inner case, for transmitting heat to the cooking chamber.

The convection assembly is mounted in the outfit room.

The microwave oven further includes a cooling fan on an upper surface of the outfit room for directing air downward for cooling the electric parts and the convection assembly.

In the meantime, the microwave oven further includes a cooling fan at a rear upper corner of the outfit room for cooling the electric parts and the convection assembly. The cooling fan is mounted tilted to face a front lower side of the outfit room for directing air toward the electric parts and a side of the convection assembly.

The body has an inlet in a front surface for introducing external air, and the outfit room has an opening for guiding the external air introduced into the body through the inlet to the outfit room.

The cooling fan is under the opening for cooling the electric parts and the convection assembly. The cooling fan is mounted tilted to face a front lower side of the outfit room for directing air toward the electric parts and a side of the convection assembly.

In the meantime, the outfit room has an exhaust opening in an upper surface for discharging air from the outfit room. The microwave oven further includes a flow guide in the outfit room for guiding air from the outfit room to the exhaust opening.

The flow guide includes one end surrounding the magnetron, and the other end connected to the exhaust opening.

The microwave oven further includes an exhaust duct in an upper portion of the outfit room in communication with the outfit room for discharging external air introduced into the outfit room to an outside of the body. The exhaust duct is extended to a front of the body, to discharge air from the outfit room to front of the body.

There is a flow guide in the outfit room for guiding air introduced into the outfit room to the exhaust duct. The flow guide includes one end surrounding the magnetron, and the other end connected to the exhaust opening.

The microwave oven further includes first, and second holes in a bottom of the body, an exhaust fan on an upper surface of the inner case for introducing air into an inside of the body through the first, and second holes, and an exhaust opening in an upper surface of the body for discharging air passed through the exhaust fan to an outside of the body.

Between the body and the outfit room, there is a second exhaust flow passage for guiding air introduced through the second hole to the exhaust fan. There is an exhaust duct in an upper portion of the outfit room for discharging external air introduced into the outfit room to an outside of the body.

The exhaust duct is in communication with the second exhaust flow passage. There is a flow guide in the outfit room in communication with the outfit room for guiding air introduced into the outfit room to the exhaust duct.

It is to be understood that both the foregoing description and the following detailed description of the present invention are exemplary and explanatory and are intended to provide further explanation of the invention claimed.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a section of a related art microwave oven;

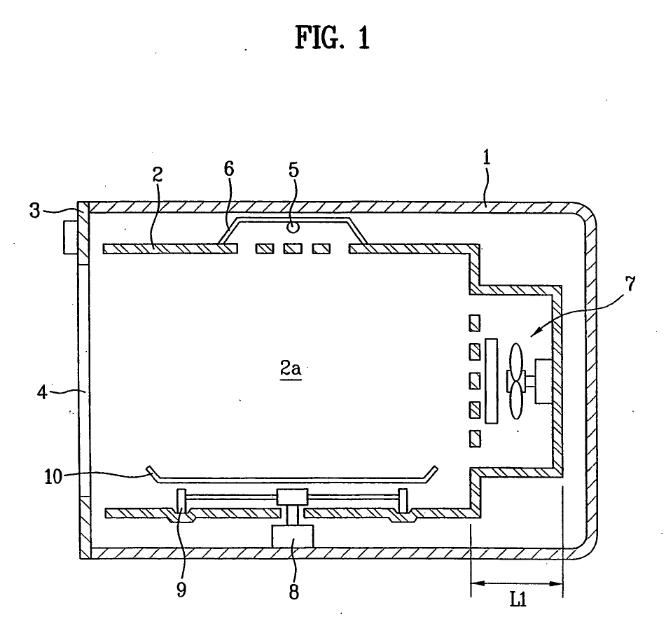

FIG. 2 illustrates a section of a related art OTR type microwave oven;

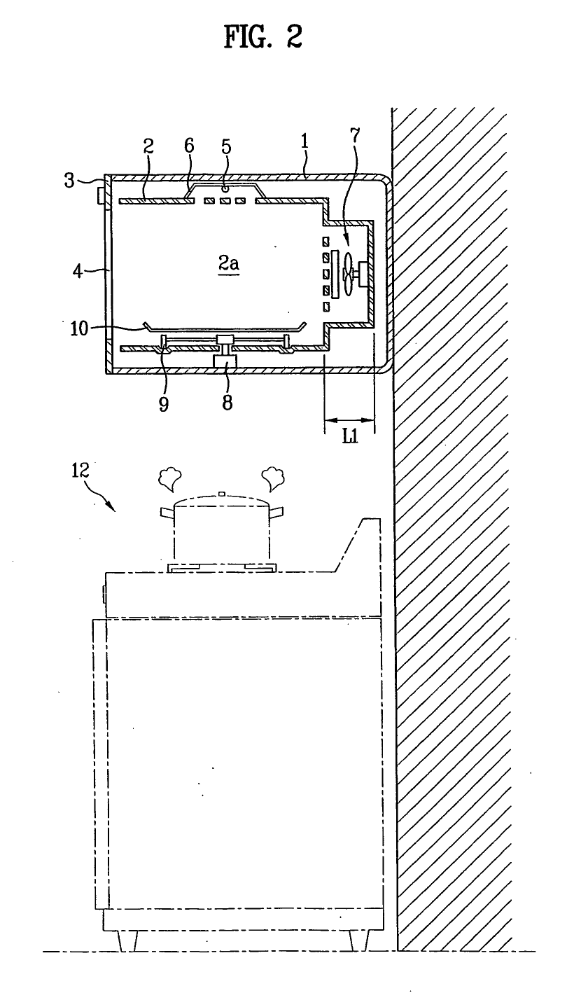

FIG. 3 illustrates a section of a microwave oven in accordance with a first preferred embodiment of the present invention;

FIG. 4 illustrates a side view of the outfit room in FIG. 3;

FIG. 5 illustrates a diagram of a convection assembly in accordance with a preferred embodiment of the present invention;

FIG. 6 illustrates a section of a microwave oven in accordance with a second preferred embodiment of the present invention;

FIG. 7 illustrates a section of a microwave oven in accordance with a third preferred embodiment of the present invention;

FIG. 8 illustrates a section across a line I-I in FIG. 7;

FIG. 9 illustrates a section of a microwave oven in accordance with a fourth preferred embodiment of the present invention; and

FIG. 10 illustrates a section across a line I-I in FIG. 9.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

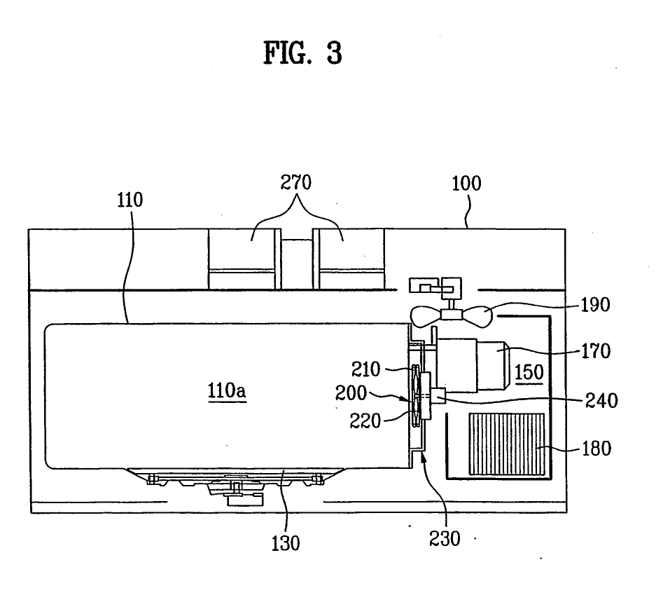

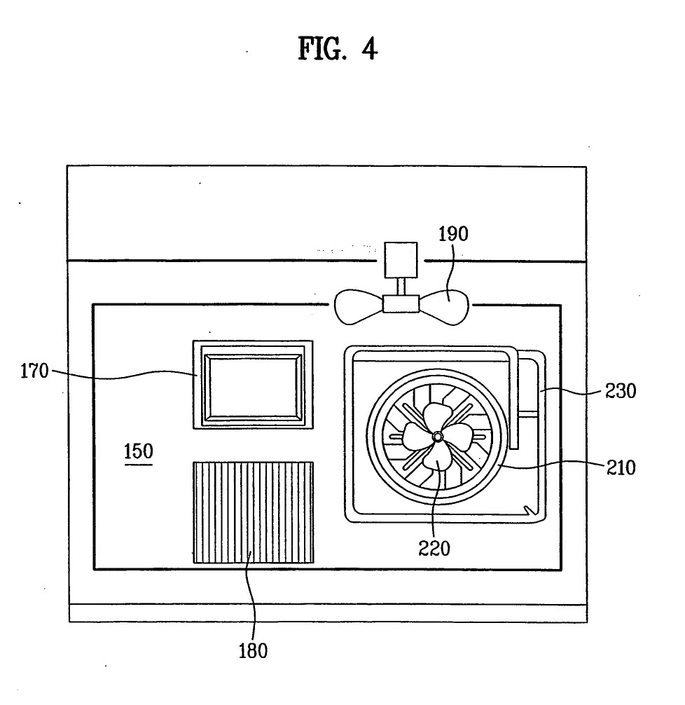

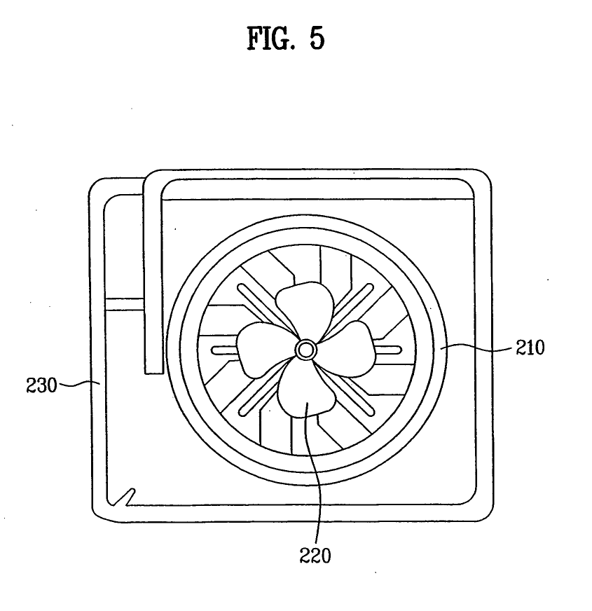

FIG. 3 illustrates a section of a microwave oven in accordance with a first preferred embodiment of the present invention, FIG. 4 illustrates a side view of the outfit room in FIG. 3, and FIG. 5 illustrates a diagram of a convection assembly in accordance with a preferred embodiment of the present invention.

Referring to FIG. 3, the microwave oven includes a body 100 forming an outer appearance, and an inner case 110 inside of the body 100.

Inside of the inner case 110, there is a cooking chamber 110a for cooking food, with a turntable 130 on a bottom for placing the food thereon. It is preferable that the turntable 130 has an adjustable height for uniform heating of the food by a convection assembly 200 to be described hereafter.

At one side of the inner case 110, there is an outfit room 150 having various electric parts, such as a magnetron 170 for generating a microwave, a high voltage transformer 180, and the like mounted therein.

In the meantime, there is also a convection assembly 200 in the outfit chamber 150 for transmission of heat to the cooking chamber 110a.

Referring to FIG. 4, the convection assembly 200 includes a heater 210, a convection fan 220, and a heater cover 230 for enclosing the heater 210, and the convection fan 220.

The heater 210 generates heat, and the convection fan 220 coupled to the fan motor 240 with a shaft for transmission of heat from the heater 210 to the cooking chamber 110a.

In more detail, referring to FIG. 5, the heater 210 has a ring shape, and the convection fan 220 is smaller than a diameter of the heater 210. The heater 210 is mounted closer to the cooking chamber 110a than the convection fan 220.

The heater cover 230 protects the heater 210 and the convection fan 220, and prevents the magnetron 170 suffering from damage by heat of the heater 210.

The convection assembly 200 may further include temperature gages (not shown) for sensing an inside temperature of the cooking chamber 110a, or a temperature of the heater 210.

The convection assembly 200 is connected to a controller (not shown) which controls operation of the microwave oven with a lead wire (not shown). That is, the controller provides a predetermined signal to the convection assembly 200 through the lead wire according to an operation mode of the microwave oven, to control operation of the heater 210, and convection fan 220.

In the meantime, above the outfit room 150, there is a cooling fan 190 for cooling the electric parts and the convection assembly 200. The cooling fan 190 directs air downward for prevention of overheating of the electric parts and the convection assembly 200.

In more detail, upon putting the microwave oven into operation, the outfit room 150 is heated by the heat from the electric parts and the convection assembly 200, which is liable to damage the electric parts and the convection assembly 200. To cope with this, the cooling fan 190 is provided for directing air toward the electric parts, and the convection assembly 200, both of which are under operation.

If the microwave oven is of the OTR type, an exhaust fan 270 is mounted on the inner case 110. The exhaust fan 270 is coupled to an exhaust motor 280, for drawing smoke and the like produced from a gas oven range, and the like, installed under the microwave oven through a bottom of the microwave oven and discharging to an outside of the room through an upper or rear surface of the body 100.

Thus, the mounting of the convection assembly 200 inside of the outfit room 150 enables the microwave oven in accordance with the first preferred embodiment of the present invention to shorten the front-rear distance.

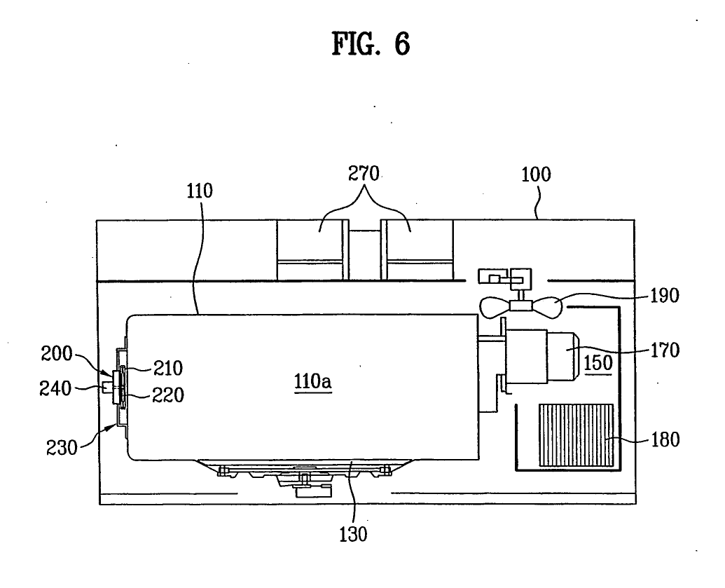

FIG. 6 illustrates a section of a microwave oven in accordance with a second preferred embodiment of the present invention.

Referring to FIG. 6, the microwave oven in accordance with a second preferred embodiment of the present invention includes an inner case 110, an outfit room 150 at one side of the inner case 110, and a convection assembly 200 at the other side of the inner case 110.

According to this, different from the first embodiment, the microwave oven in accordance with a second preferred embodiment of the present invention has no convection assembly 200 mounted in the outfit room 150. That is, the outfit room 150 and the convection assembly 200 are mounted at left and right sides of the inner case 110, respectively.

The convection assembly 200 is provided with a separate cooling fan (not shown) for cooling. That is, different from the first embodiment, the cooling fan 190 in the outfit room 150 serves only to cool down the electric parts. Therefore, the microwave oven in. accordance with a second preferred embodiment of the present invention is provided with a separate cooling fan (not shown) for cooling the convection assembly 200.

Thus, alike the first embodiment, the microwave oven in accordance with a second preferred embodiment of the present invention can also shorten the front-rear distance because the convection assembly 200 is mounted at a side of the inner case 110.

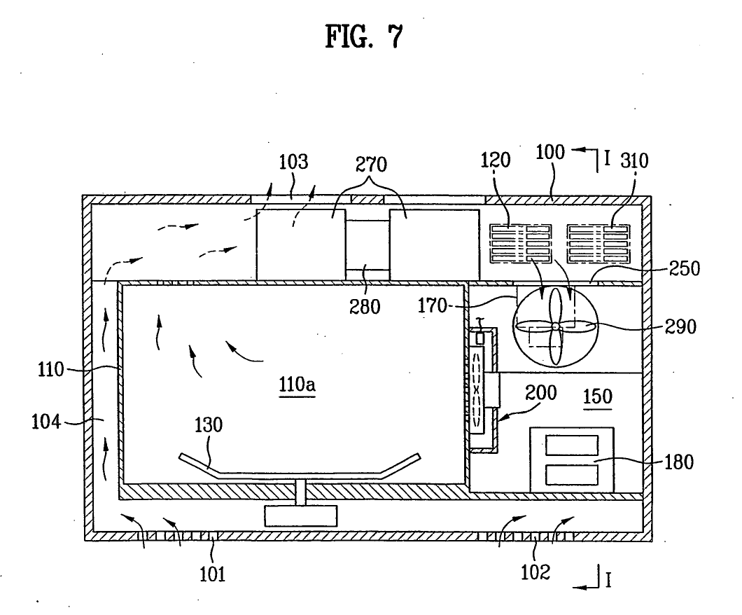

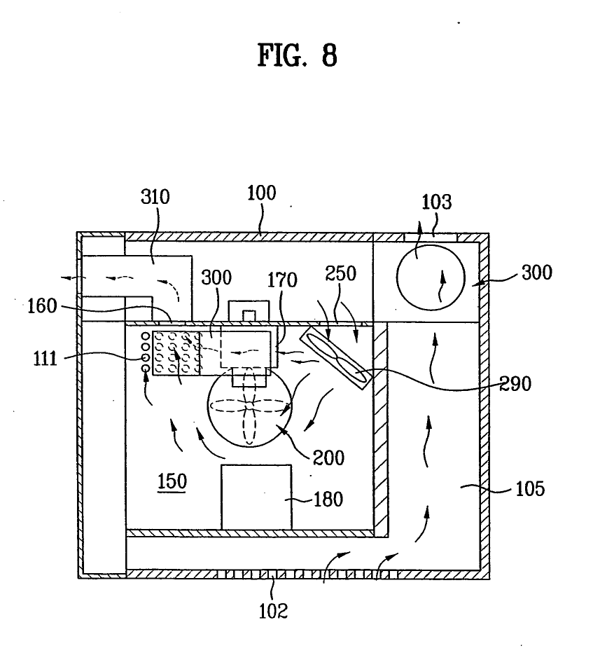

FIG. 7 illustrates a section of a microwave oven in accordance with a third preferred embodiment of the present invention, and FIG. 8 illustrates a section across a line I-I in FIG. 7.

Referring to FIGS. 7 and 8, alike above embodiments, the microwave oven in accordance with a third preferred embodiment of the present invention includes a body 100, an inner case 110, an outfit room 150, and a convection assembly 200.

Inside of the outfit room 150, there are various electric parts and the convection assembly mounted therein. In more detail, as described before, inside of the outfit room 150, there are electric parts, such as a magnetron 170 for generating a microwave, and a high voltage transformer 180.

The magnetron 170 is mounted on an upper surface of the outfit room 150, and the high voltage transformer 180 is mounted on a bottom of the outfit room 150. In this instance, a wave guide is mounted along upper surfaces of the outfit room 150, and the inner case 110 for transmission of the microwave from the magnetron 150 to the cooking chamber.

Alike the first embodiment, inside of the outfit room 150, there is the convection assembly 200 mounted therein. The convection assembly 200 is mounted on a side surface of the inner case 110, for transmission of heat to the cooking chamber 110a.

At an upper rear corner of the outfit room 150, there is a cooling fan 290 for cooling the electric parts and the convection assembly 200.

In this instance, the cooling fan 290, mounted tilted to face a front lower side of the outfit room 150, directs air toward the electric parts and a side of the convection assembly 200.

In the meantime, the body 100 has an air inlet 120 in a front surface, and the outfit room 150 has an opening 250 in an upper surface for guiding the air introduced into the body 100 through the inlet 120 to the outfit room 150.

Therefore, the air, introduced into a space defined by the body 100 and the outfit room 150 through the inlet 120, is introduced into the outfit room 150 through the opening 250. At the end, air keeps being introduced into the outfit room 150 through the inlet 120, and the opening 250, for cooling the electric parts and the convection assembly 200.

The cooling fan 290 is mounted under the opening 250 for directing air toward the electric parts and the convection assembly 200.

In the meantime, the air introduced into the outfit room 150 is heated as the air cools down the electric parts and the convection assembly 200 by the cooling fan 290.

If the heated air is stagnant in the outfit room 150, the heated air is liable to damage the parts in the outfit room 150, on the contrary. Therefore, it is required to discharge the heated air to an outside of the outfit room 150, as soon as possible.

For this, there are a plurality of air introduction holes 111 in a side surface of the inner case 110 the outfit room 150 is provided thereto in communication with the cooking chamber 110a. Accordingly, the air blow by the cooling fan 290 is discharged to the cooking chamber 110a through the air introduction holes 111 after cooling the electric parts and the convection assembly 200.

There is an air outlet hole (not shown) in a rear surface of the inner case 200 for discharging the air introduced into the cooking chamber 110a.

However, above air flow is not made once the convection assembly 200 is put into operation for cooking food. That is, once the convection assembly 200 is put into operation, a damper (not shown) closes the air introduction holes 111 for elevating an inside temperature of the cooking chamber 110a, to shut off the introduction of air into the cooking chamber 110a.

Accordingly, during the convection assembly 200 is in operation, the heated air is stagnant in the outfit room 150, which is liable to damage the electric parts and the convection assembly 200.

In order to prevent this, in an upper surface of the outfit room 150, there is an outlet 160 for discharging air introduced into the outfit room 150. The outlet 160 enables discharge of air to an outside of the outfit room 150 even in a case the air introduction holes 111 are closed by the damper, to prevent the heated air from stagnant in the outfit room 150.

Moreover, there is a flow guide 300 in the outfit room 150, for guiding the air to the outlet 160, to make smooth discharge of the air from the outfit room 150 to an outside of the outfit room 150.

It is preferable that the flow guide 300 has one end configured to surround the magnetron 170, and the other end configured to be connected to the outlet 160. The air directed toward the magnetron 170 cools down the magnetron 170, and discharged to an outside of the outfit room 150 at once through the flow guide 300 and the outlet 160. According to this, the flow guide 300 enables to prevent the heated air from being stagnant in the outfit room 150, effectively.

In the meantime, additionally, there is an exhaust duct 310 in an upper portion of the outfit room 150 for discharging the air introduced into the outfit room 150 to an outside of the body 100. The exhaust duct 310 is in communication with the outfit room 150, for smooth discharge of the air to an outside of the body 100.

The exhaust duct 310 is extended to a front of the body 100 for discharging air from the outfit room 150 to front of the body 100. Of course, the exhaust duct 310 may be extended in a rear or a side of the body 100, for discharging the air from the outfit room 150 to the rear or side of the body 100.

The exhaust duct 310 in the upper portion of the outfit room 150 enables to discharge air from the outfit room 150 to the front of the body 100 after guided to the exhaust duct 310 through the flow guide 300.

In the meantime, in a case of the OTR type microwave oven, the body 100 has first, and second inlet holes 101, and 102 in a bottom surface, and the inner case 110 has an exhaust fan 270 in the upper portion 110 for introducing air into the body 100 through the first, and second inlet holes 101, and 102.

In more detail, the exhaust fan 270 coupled to a driving motor 280 generates suction force so that smoke and the like produced from a gas oven range, or the like under the microwave oven is introduced into the body 100 through the first, and second inlet holes 101, and 102.

There is an exhaust opening 103 in an upper surface of the body 100 for discharging air passed through the exhaust fan 270 to an outside of the body 100. Of course, the exhaust opening 103 may be in a rear surface of the body 100.

Moreover, between the body 100, and the inner case 110, there is a first exhaust flow passage 104 for guiding the air introduced through the inlet first hole 101 to the exhaust fan 270, and between the body 100 and the outfit room 150, there is a second exhaust flow passage 105 for guiding the air introduced through the second inlet hole 102 to the exhaust fan 270.

Accordingly, the air introduced through the first inlet hole 101 is guided to the exhaust fan 270 through the first exhaust flow passage 104, and the air introduced through the second inlet hole 102 is guided to the exhaust fan 270 through the second exhaust flow passage 105.

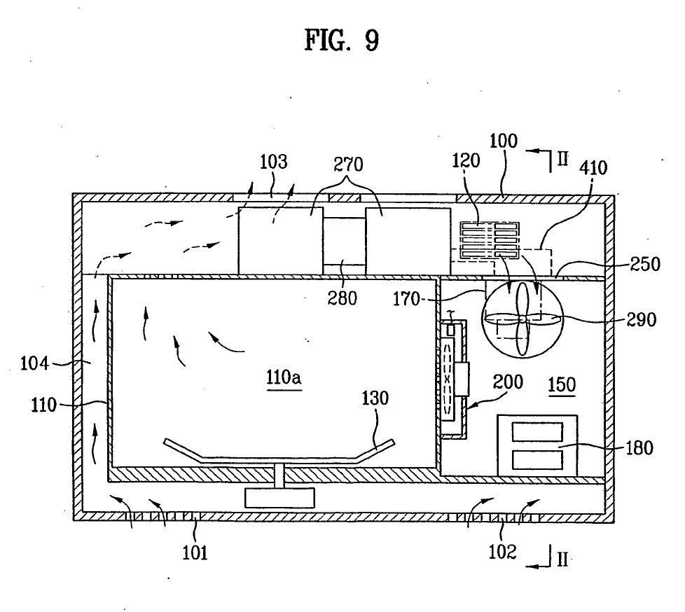

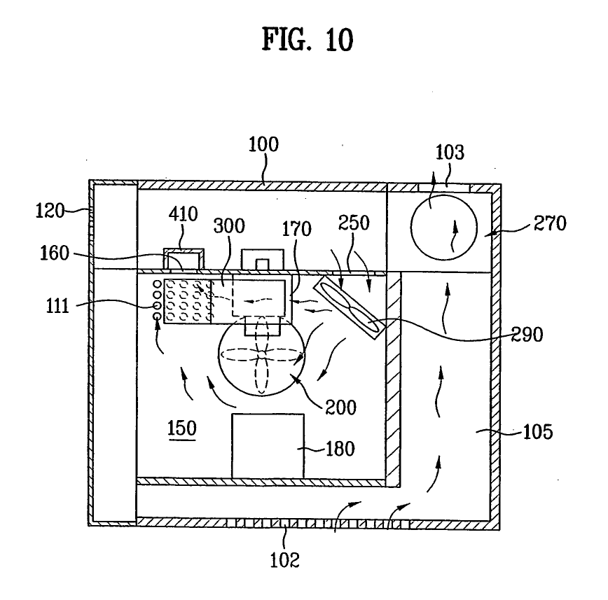

FIG. 9 illustrates a section of a microwave oven in accordance with a fourth preferred embodiment of the present invention, and FIG. 10 illustrates a section across a line I-I in FIG. 9.

Referring to FIGS. 9 and 10, the microwave oven in accordance with a fourth preferred embodiment of the present invention has an exhaust duct 410 configured to be in communication with a space having suction force of exhaust fan 270 transmitted thereto.

In more detail, it is preferable that the exhaust duct 410 is configured to be in communication with the second exhaust flow passage 105. Therefore, upon putting the exhaust fan 270 into operation, air suction force of the exhaust fan 270 is made to be applied even to an inside of the outfit room 150 through the exhaust duct 410.

If the exhaust duct 410 is provided to be in communication with the second exhaust flow passage 105, the air is forcibly discharged from the outfit room 150 to an outside of the body by air suction force of the exhaust fan 270.

That is, the air is guided from the outfit room 150 to the exhaust fan 270 through the exhaust duct 410 and the second exhaust flow passage 105, and discharged to an outside of the body 100 through the exhaust opening 103.

According to this, the heated air is discharged from the outfit room 150 to an outside of the body 100 more quickly, to cool down the various electric parts and the convection assembly 200, more smoothly.

### INDUSTRIAL APPLICABILITY

The present invention has the following advantages.

First, the mounting of the convection assembly at a side of the inner case enables to reduce a front-rear distance of the microwave oven, permitting to make the microwave oven smaller, or to make a cooking chamber thereof larger for the same size of the microwave ovens.

Moreover, when the convection assembly is mounted in the outfit room, the cooling fan for the outfit room can cool down the electric parts and the convection assembly at the same time, permitting to dispense with separate parts required for cooling the convection assembly.

Second, the possibility of discharging air from the outfit room to an outside of the body through the exhaust opening or the exhaust duct provided separately in the upper surface of the outfit room permits to prevent heated air from being stagnant in the outfit room.

Particularly, when the microwave oven is in a convection mode, the prevention of stagnation of the heated air in the outfit room prevents the electric parts and the convection assembly suffering from damage.

Third, the forced discharge air from the outfit room by an exhaust fan permits to cool down the electric parts and the convection assembly in the outfit room, more quickly.

What is claimed is:

1. A microwave oven comprising:
a body forming an outer appearance;
an inner case in the body having a cooking chamber formed therein;
an outfit room at one side of the inner case, having various electric parts, such as a magnetron, a high voltage transformer, mounted therein; and
a convection assembly mounted at a side of the inner case, for transmitting heat to the cooling chamber.

2. The microwave oven as claimed in claim 1, wherein the convection assembly is mounted in the outfit room.

3. The microwave oven as claimed in claim 2, further comprising a cooling fan on an upper surface of the outfit room for directing air downward for cooling the electric parts and the convection assembly.

4. The microwave oven as claimed in claim 2, further comprising a cooling fan at a rear upper corner of the outfit room for cooling the electric parts and the convection assembly.

5. The microwave oven as claimed in claim 4, wherein the cooling fan is mounted tilted to face a front lower side of the outfit room for directing air toward the electric parts and a side of the convection assembly.

6. The microwave oven as claimed in claim 2, wherein the body has an inlet in a front surface for introducing external air, and the outfit room has an opening for guiding the external air introduced into the body through the inlet to the outfit room.

7. The microwave oven as claimed in claim 6, wherein the cooling fan is under the opening for cooling the electric parts and the convection assembly.

8. The microwave oven as claimed in claim 7, wherein the cooling fan is mounted tilted to face a front lower side of the outfit room for directing air toward the electric parts and a side of the convection assembly.

9. The microwave oven as claimed in claim 2, wherein the outfit room has an exhaust opening in an upper surface for discharging air from the outfit room.

10. The microwave oven as claimed in claim 9, further comprising a flow guide in the outfit room for guiding air from the outfit room to the exhaust opening.

11. The microwave oven as claimed in claim 10, wherein the flow guide includes one end surrounding the magnetron, and the other end connected to the exhaust opening.

12. The microwave oven as claimed in claim 2, further comprising an exhaust duct in an upper portion of the outfit room in communication with the outfit room for discharging external air introduced into the outfit room to an outside of the body.

13. The microwave oven as claimed in claim 12, wherein the exhaust duct is extended to a front of the body, to discharge air from the outfit room to front of the body.

14. The microwave oven as claimed in claim 12, wherein there is a flow guide in the outfit room for guiding air introduced into the outfit room to the exhaust duct.

15. The microwave oven as claimed in claim 10, wherein the flow guide includes one end surrounding the magnetron, and the other end connected to the exhaust opening.

16. The microwave oven as claimed in claim 2, further comprising:
first, and second holes in a bottom of the body;
an exhaust fan on an upper surface of the inner case for introducing air into an inside of the body through the first, and second holes; and
an exhaust opening in an upper surface of the body for discharging air passed through the exhaust fan to an outside of the body.

17. The microwave oven as claimed in claim 16, wherein, between the body and the outfit room, there is a second exhaust flow passage for guiding air introduced through the second hole to the exhaust fan.

18. The microwave oven as claimed in claim 16, wherein there is an exhaust duct in an upper portion of the outfit room for discharging external air introduced into the outfit room to an outside of the body.

19. The microwave oven as claimed in claim 18, wherein the exhaust duct is in communication with the second exhaust flow passage.

20. The microwave oven as claimed in claim 18, wherein there is a flow guide in the outfit room in communication with the outfit room for guiding air introduced into the outfit room to the exhaust duct.
